(19) United States
(12) Patent Application Publication
(10) Pub. No.: US 2011/0311933 A1
(43) Pub. Date: Dec. 22, 2011

(54) ORTHODONTIC DEVICE

(75) Inventor: Stan Newton Parker, Largo, FL (US)

(73) Assignee: PARKER ORTHODONTICS, Indian Rocks Beach, FL (US)

(21) Appl. No.: 12/857,548

(22) Filed: Aug. 16, 2010

Related U.S. Application Data
(60) Provisional application No. 61/356,598, filed on Jun. 19, 2010.

(51) Int. Cl. A61C 7/12

(52) U.S. Cl. 433/9

(57) ABSTRACT

Systems, methods and apparatus are provided through which in some implementations at least one tooth-bonding-pad is slidably mounted to an archwire. In some implementations, the archwire passes through the at least one tooth-bonding-pad and in some other implementations, the archwire passes through at least one tubular holder that is mounted on each of the at least one tooth-bonding-pads.

### RELATED APPLICATION

This application claims the benefit of U.S. Provisional Application Ser. No. 61/356,598 titled “Orthodontic Device” filed 19 Jun. 2010 under 35 U.S.C. 119(e).

### FIELD

This disclosure relates generally to orthodontic devices, and more particularly to orthodontic archwire devices.

### BACKGROUND

In orthodontics, an orthodontic archwire is ligated to a number of orthodontic brackets, each of which has a tooth-bonding-pad as a part of a bracket. An orthodontic archwire is a wire conforming to the alveolar or dental arch that can be used with dental tooth-bonding pads and brackets as a source of force in correcting irregularities in the position of the teeth. The dental tooth-bonding pads are attached to the brackets and the brackets are attached to the archwire. The archwire is attached to the brackets by a dental or orthodontic practitioner in the mouth of a patient.

### BRIEF DESCRIPTION OF THE DRAWINGS

FIG. 1 is a block diagram of an overview of a slideable unitary tooth-bonding-pad/archwire apparatus, according to an implementation;

FIG. 2 is an occlusal view of a cross section block diagram of an apparatus according to an implementation illustrating an archwire passing through an interior of a tooth-bonding-pad;

FIG. 3 is a distal or mesial view of a cross section block diagram of an apparatus according to an implementation illustrating an archwire passing through an interior of a tooth-bonding-pad;

FIG. 4 is a buccal view of a cross section block diagram of an apparatus according to an implementation illustrating an archwire passing through an interior of a tooth-bonding-pad;

FIG. 5 is an occlusal-view block diagram of a slideable unitary tooth-bonding-pad/archwire apparatus applied to a molar tooth, a bicuspid tooth and a canine tooth, according to an implementation;

FIG. 6 is a buccal-view block diagram of a slideable unitary tooth-bonding-pad/archwire apparatus applied to a molar tooth, a bicuspid tooth and a canine tooth, according to an implementation;

FIG. 7 is a buccal side-view block diagram of a slideable unitary tooth-bonding-pad/archwire apparatus having a tubular holder of the archwire applied to a bicuspid tooth, according to an implementation;

FIG. 8 is an occlusal-view block diagram of a slideable unitary tooth-bonding-pad/archwire apparatus having a tubular holder of the archwire applied to a bicuspid tooth, according to an implementation;

FIG. 9 is a mesial view block diagram of a slideable unitary tooth-bonding-pad/archwire apparatus having a tubular holder of the archwire applied to a bicuspid tooth, according to an implementation;

FIG. 10 is a flowchart of a method to fabricate a slideable unitary tooth-bonding-pad/archwire apparatus according to an implementation;

FIG. 11 is a flowchart of a method to implement a slideable unitary tooth-bonding-pad/archwire apparatus, according to an implementation before application of removable orthodontic appliance systems;

FIG. 12 is a flowchart of a method to implement a slideable unitary tooth-bonding-pad/archwire apparatus, to correct orthodontic relapse;

FIG. 13 is a flowchart of a method to implement a slideable unitary tooth-bonding-pad/archwire apparatus, to facilitate the application of interceptive removable orthodontic devices on patients who are in a mixed dentition age range;

FIG. 14 is a flowchart of a method to implement a slideable unitary tooth-bonding-pad/archwire apparatus, to correct a minor orthodontic malocclusion;

FIG. 15 is a flowchart of a method to implement a slideable unitary tooth-bonding-pad/archwire apparatus, in coordination with application of crowns and abutments; and

FIG. 16 is a block diagram of a method of stringing a plurality of tooth-bonding-pads onto an archwire, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, physical and other changes may be made without departing from the scope of the implementations. The following detailed description is, therefore, not to be taken in a limiting sense.

Apparatus, systems, and methods of varying scope are described herein. In addition to the aspects and advantages described herein, further aspects and advantages will become apparent by reference to the drawings and by reading the detailed description that follows.

The detailed description is divided into four sections. In the first section, a system level overview is described. In the second section, apparatus of implementations are described. In the third section, implementations of methods are described. Finally, in the fourth section, a conclusion of the detailed description is provided.

### System Level Overview

A system level overview of the operation of an implementation is described in this section of the detailed description.

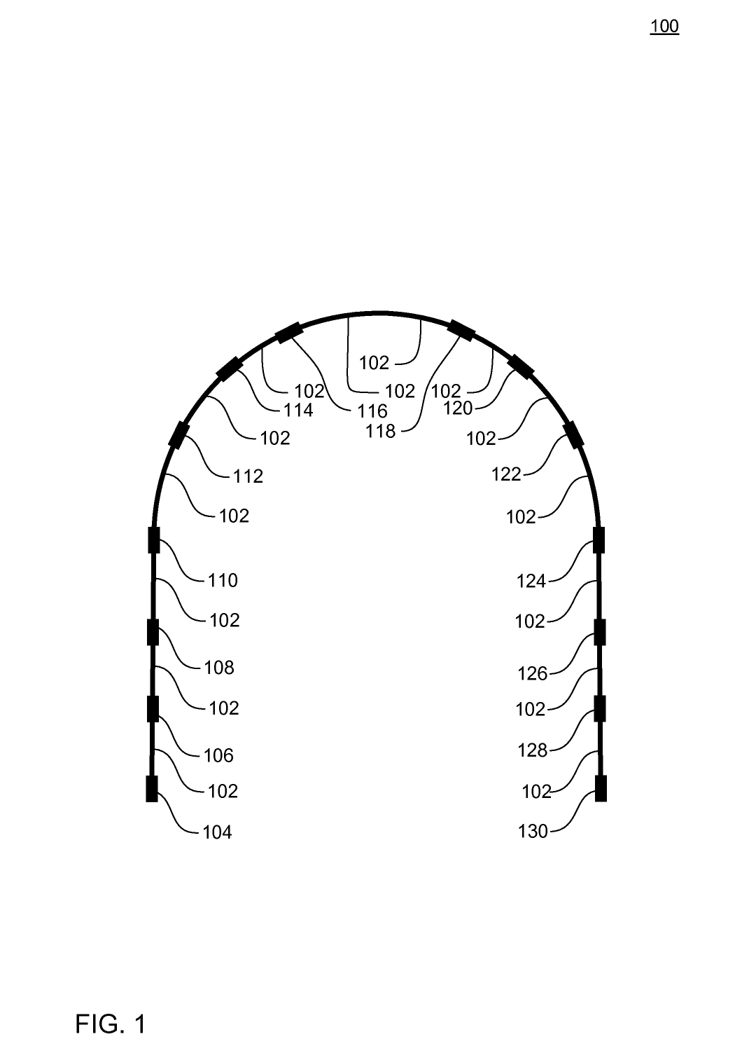

FIG. 1 is a block diagram of an overview of a slideable unitary tooth-bonding-pad/archwire apparatus 100, according to an implementation. Apparatus 100 can be described as a slideable .

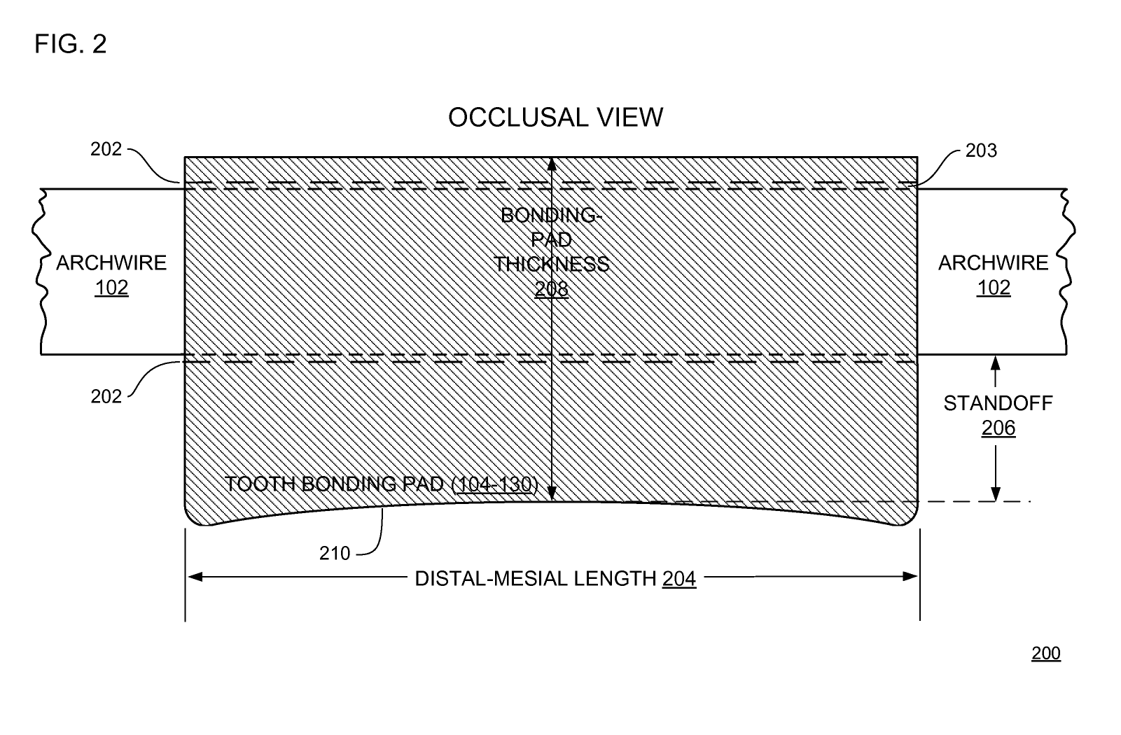

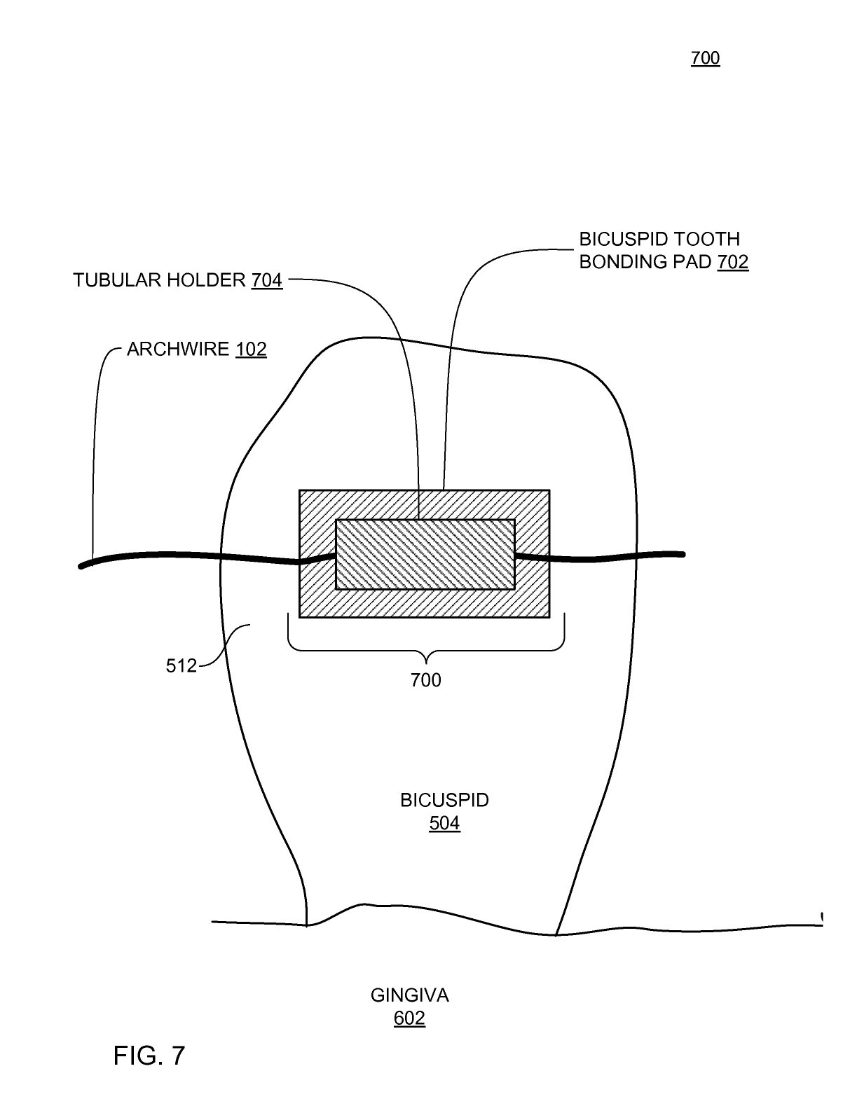

Apparatus 100 includes an archwire 102 and a plurality of tooth-bonding-pads 104, 106, 108, 110, 112, 114, 116, 118, 120, 122, 124, 126, 128 and 130. Each of the plurality of tooth-bonding-pads 104-130 are slideably or moveably mounted on the archwire 102. None of the plurality of tooth-bonding-pads 104-130 are ligated to the archwire 102. In the implementations shown in FIG. 2-4, the slidable or moveable mounting of the tooth-bonding-pads 104-130 on the archwire 102 includes no attachment between the tooth-bonding-pads 104-130 on the archwire 102. In the implementations shown in FIG. 7-9, the slidable or moveable mounting of the tooth-bonding-pads 104-130 on the archwire 102 include a tubular holder between the tooth-bonding-pads 104-130 on the archwire 102. Nonetheless in the implementations shown in FIGS. 2-4 and 7-9, the slideable or moveable mounting reduces friction which decreases treatment time. In some implementations, the slideably or moveably mounting of the plurality of tooth-bonding-pads 104-130 on the archwire 102 is merely the archwire 102 being threaded through the plurality of tooth-bonding-pads 104-130.

The slidable or moveable mounting of the tooth-bonding-pads 104-130 on the archwire 102 provides significantly reduced friction between the tooth-bonding-pads 104-130 and the archwire 102, and because the slidable or moveable mounting of the tooth-bonding-pads 104-130 on the archwire 102 provides orthodontic correction with the use of a single archwire. The reduced friction between the tooth-bonding-pads 104-130 and the archwire 102 speeds tooth movement, and facilitates orthodontic correction in shorter times than could otherwise be obtained

Additionally, the slidable or moveable mounting of the tooth-bonding-pads 104-130 on the archwire 102 achieve orthodontic correction with the use of a single archwire, is well-suited for use in orthodontic corrections which are not normally addressed by the currently produced bracket-archwire systems which require use of multiple archwires and associated archwire changes.

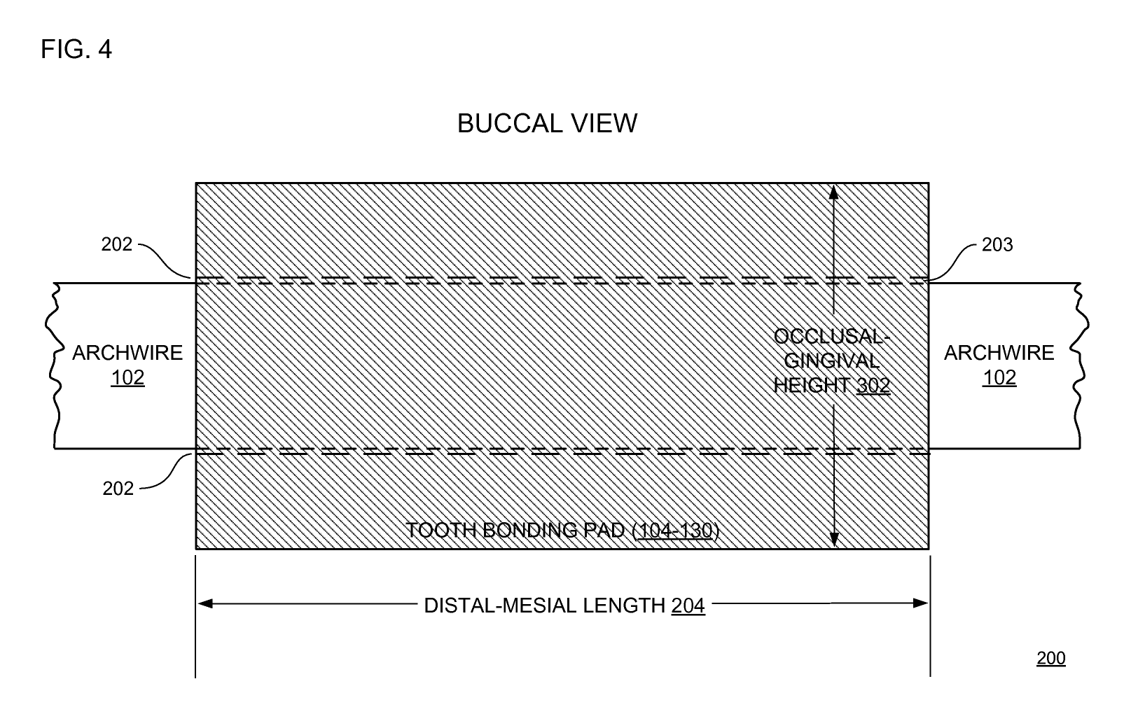

An important feature in some implementations of apparatus 100 is that the apparatus 100 does not have or include an orthodontic bracket. The lack of an orthodontic bracket simplifies the fabrication of the apparatus 100. The lack of an orthodontic bracket also improves the comfort of a patient to which the apparatus 100 is applied. The absence of an orthodontic bracket provides a lower physical profile and a smaller height dimension, as shown in FIG. 4. The lower physical profile of apparatus 100 positions the archwire 102 further away from the inside of the cheek of the patient to which the apparatus 100 is applied, thus reducing friction of the inside of the cheek on the archwire 102, and thus improving comfort of the patient to which the apparatus 100 is applied.

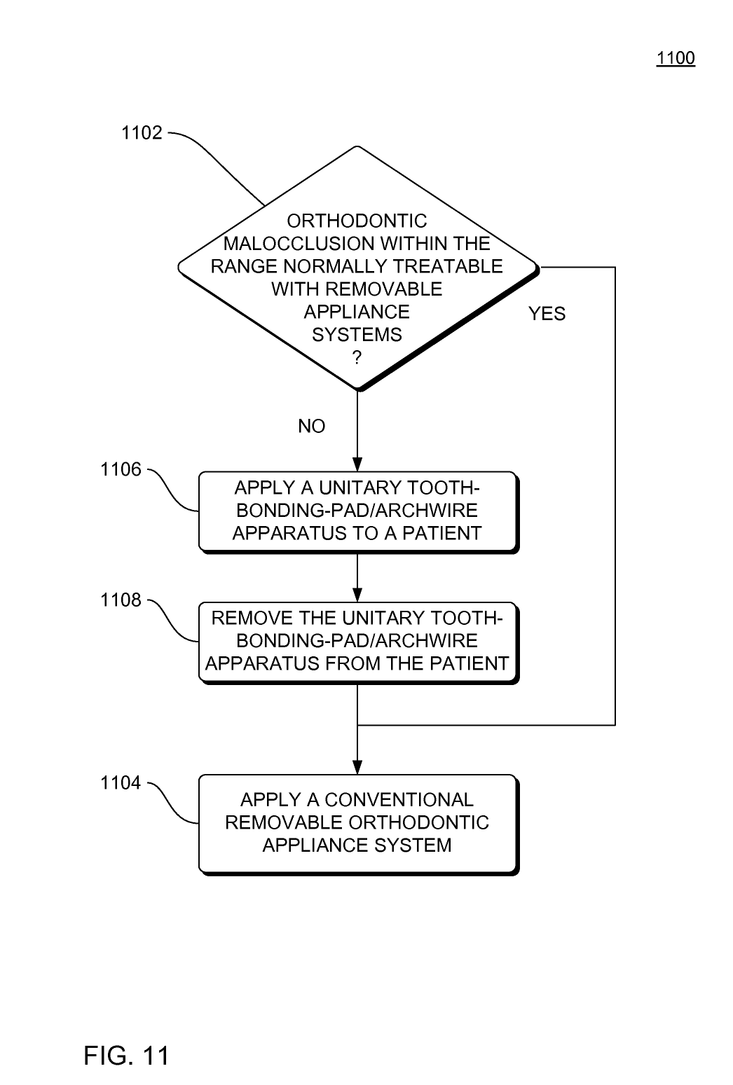

Apparatus 100 can be implemented as an enabling appliance for orthodontic patients who, without prior treatment using apparatus 100, would not be practical candidates for complete and finishing orthodontic treatment with other removable orthodontic appliance systems, as described in greater detail in FIG. 11 below.

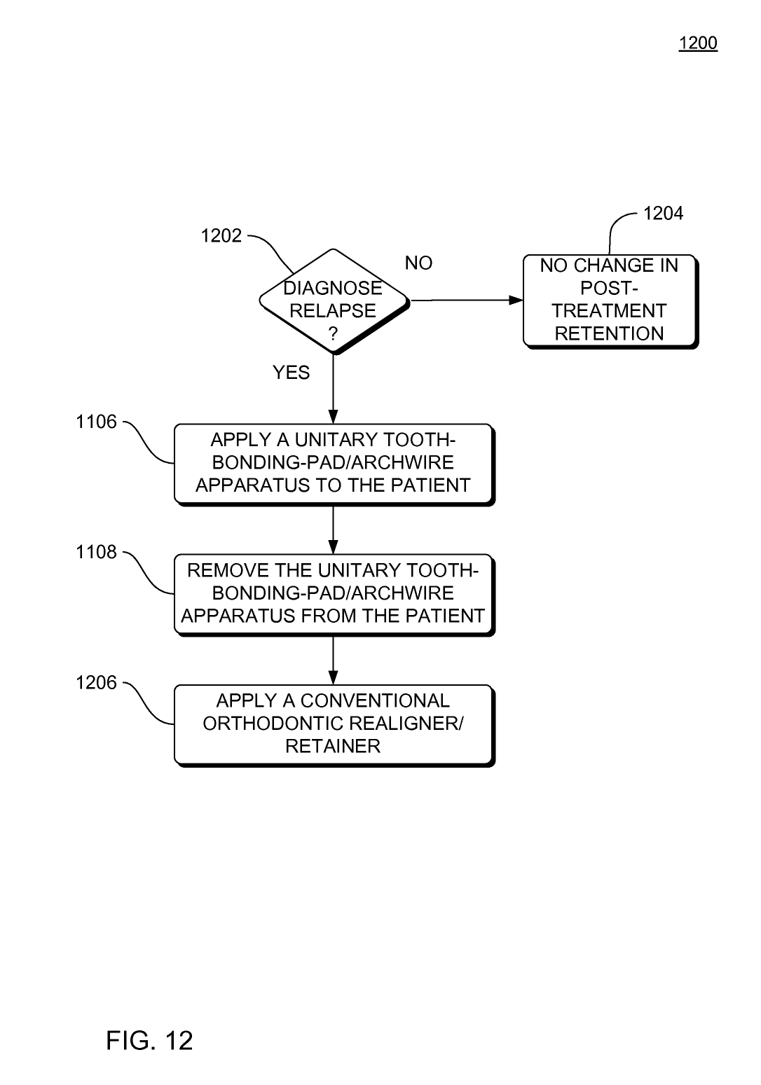

For correction of orthodontic relapse, where the degree of relapse is outside the range of treatment of a conventional realigner-retainer appliance, apparatus 100 is implemented to bring the degree of correction needed back within range of a realigner or a retainer, as described in greater detail in FIG. 12.

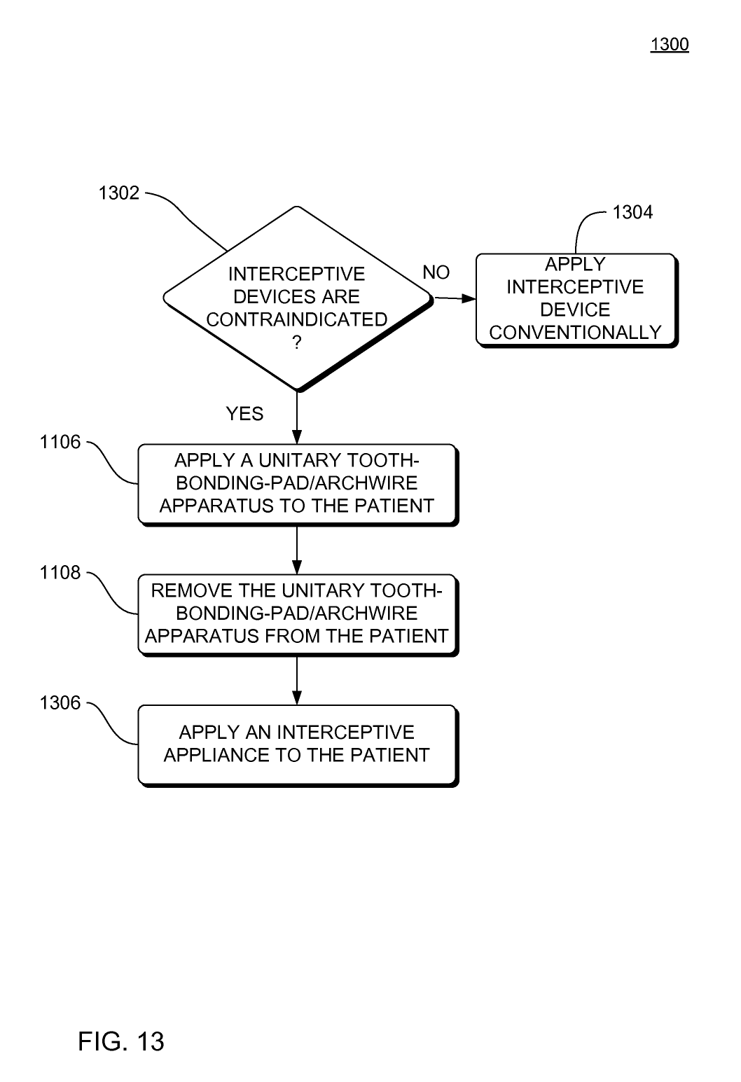

Apparatus 100 can be implemented in order to facilitate the implementation of interceptive removable orthodontic devices for patients in a mixed dentition age range. For patients who have one or more teeth positioned such that the implementation of interceptive devices would be contraindicated, these problematically positioned teeth can be moved into positions by apparatus 100 in which the positions permit the implementation of these interceptive appliances. Interceptive orthodontic appliances include Frankel orthodontic appliances, Schwarz orthodontic appliances and Bionator orthodontic appliances, as described in greater detail in FIG. 13.

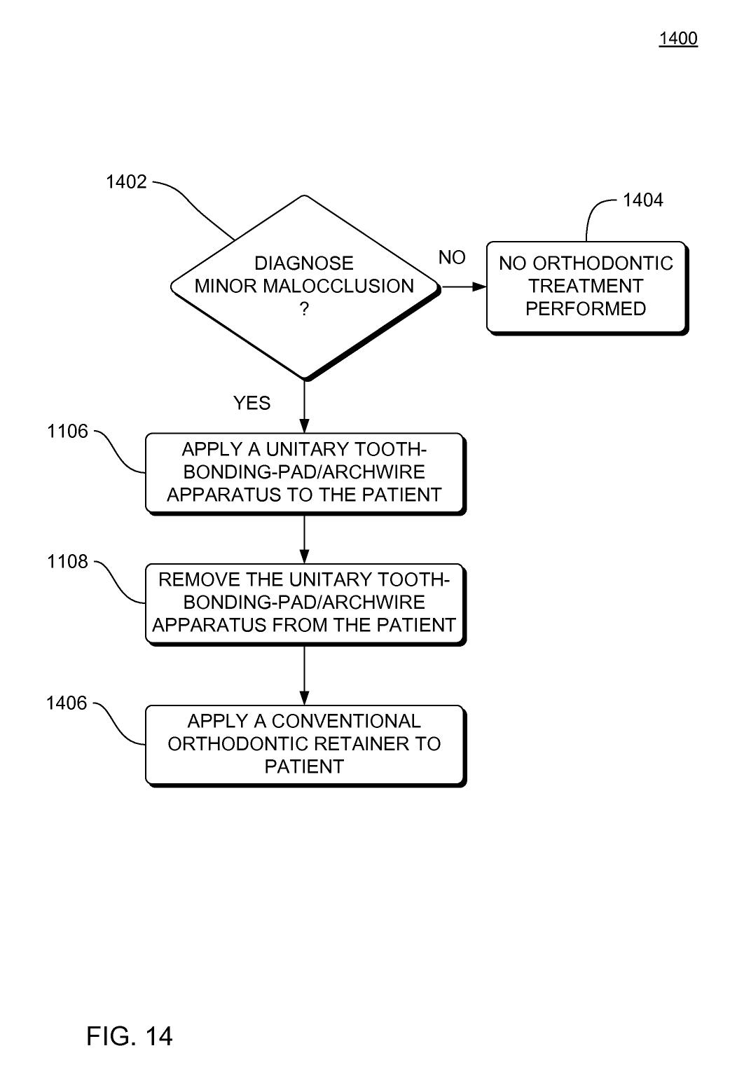

In addition apparatus 100 can be implemented as a single appliance treatment for complete orthodontic treatment in cases of minor orthodontic malocclusions. For example, in cases where a dental malocclusion consists of only minor tooth displacements, such as buccal-lingual displacements, rotations, tipping, and vertical height discrepancies, complete orthodontic treatment can be obtained with the application of apparatus 100. Following completion of orthodontic treatment using apparatus 100, any conventional retainer, such as a Hawley orthodontic appliance can be implemented to retain the orthodontic result, as described in greater detail in FIG. 14.

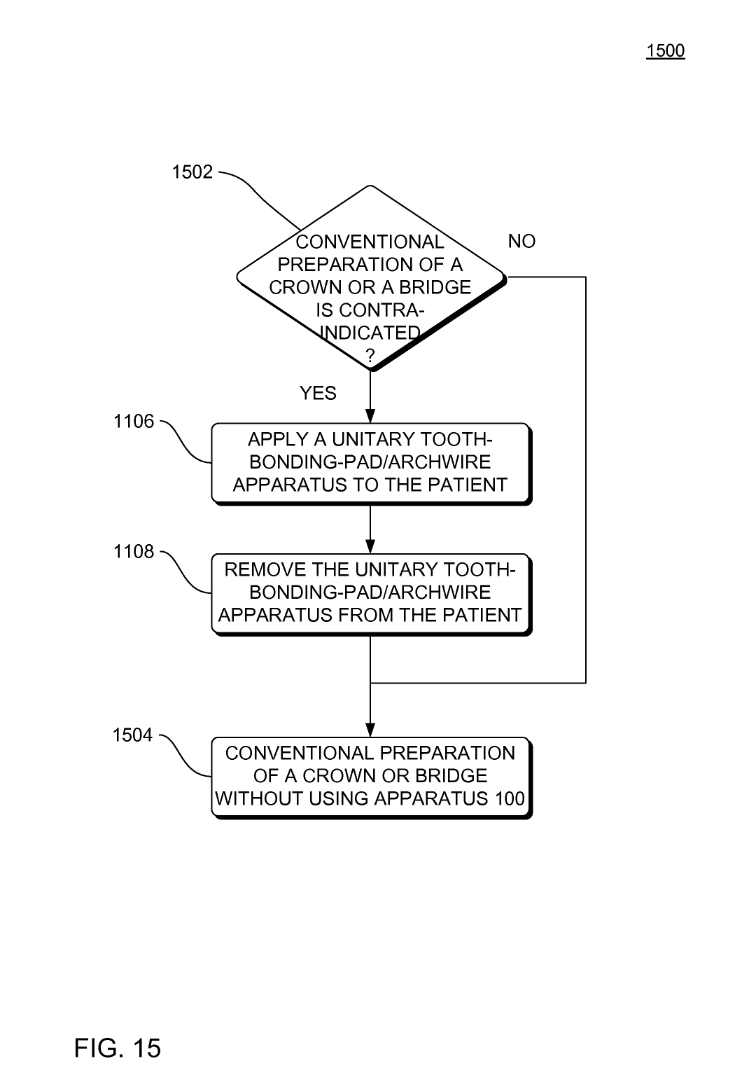

Apparatus 100 can be implemented prior to crown and bridge work in dentistry. When one or more of teeth that are to be prepared for crowns or as abutments for bridgework are in less than ideal positions, apparatus 100 can be implemented to better position these teeth for stress bearing associated with chewing forces, and also to allow for a more aesthetically appearing cosmetic result. Short term correction involving apparatus 100 aligns the anterior teeth so that conservative crown preparation will allow for a cosmetically ideal result, as described in greater detail in FIG. 15.

In some implementations of apparatus 100, the materials of the archwire 102 and/or the tooth-bonding-pads 104-130 include 0.0-5.5% iron, 7.0 to 9.0% aluminum, 3.0-5.5% nickel, 1.0-8.0% zinc, 0-2.5% manganese and the remainder being copper, or any other material that will work with conventional approved orthodontic bonding systems implemented for orthodontic bracket placement. The geometry of the tooth-bonding-pads 104-130 are of standardized bracket base form, derived from statistical tooth geometry data for labial and buccal tooth surfaces.

In the implementation shown in FIG. 1, the apparatus 100 includes 14 tooth-bonding-pads 104-130. However, other implementations can be fabricated, with any number of tooth-bonding-pads, such as 10 tooth-bonding-pads, 11 tooth-bonding-pads, 12 tooth-bonding-pads, 13 tooth-bonding-pads, 15 tooth-bonding-pads or 16 tooth-bonding-pads. The disclosure herein is not limited by the number of tooth-bonding-pads.

The locations for the tooth-bonding-pads 104-130 on the archwire 102 in FIG. 1 is one implementation. Variation among population bases and future applications associated with evolving treatment modalities alter the exact location of these tooth-bonding-pads 104-130 on the archwire 102. Additionally, the archwire 102 and tooth-bonding-pads 104-130 can be custom fabricated for a selected patient based on full arch impressions, optical or infrared scans, or calibrated photography, thus many variations in the locations for the tooth-bonding-pads 104-130 on the archwire 102 are contemplated.

In some implementations, the contours of the tooth-bonding-pads 104-130 are in accordance with existing statistical norms of the labial and buccal surfaces of the teeth. The size of the tooth-bonding-pads 104-130 are varied slightly to allow for the different force per unit deflection of the different diameter archwires.

In some implementations of apparatus 100, each of the tooth-bonding-pads have an orientation to the archwire 102 such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In further implementations, the tooth-bonding-pads are accurately appositioned with labial and buccal aspects at occlusal-gingival center and mesial-distal center to the extent that the human teeth that are not in orthodontically correct positions will experience corrective orthodontic forces moving the human teeth toward orthodontically correct positions.

In some implementations of apparatus 100, each of the tooth-bonding-pads includes at least one contour of each of the tooth-bonding-pads being produced from existing statistical norms of the labial and buccal surfaces of the teeth.

In some implementations of apparatus 100, the archwire 102 includes a nickel-titanium (NiTi) alloy metal. In some implementations of apparatus 100, the archwire 102 includes a thermally activated nickel-titanium (NiTi) alloy metal. In some implementations of the thermally activated NiTi alloy, force activation occurs at approximately 27 degrees Celsius and approximately 81 degrees Fahrenheit. Other metals that the archwire 102 can be made of include beta-Titantium, beta-Titantium-nickel, Titantium-carbide, Titanium Molybdenum alloys, stainless steel and/or nickel-cobalt alloys. In some implementations of apparatus 100, the archwire 102 includes stainless steel. In some implementations of apparatus 100, the archwire 102 includes gold. In some implementations of apparatus 100, the archwire 102 includes ceramic coated nickel titanium and stainless steel.

In some implementations of apparatus 100, the archwire 102 includes a diameter selected from the group of diameters consisting of 0.012 inches in diameter round, 0.014 inches in diameter round, 0.016 inches in diameter round, and 0.016×0.016 inches square cross section and 0.016×0.022 inches rectangular cross section.

In some implementations of apparatus 100, the archwire 102 includes a tooth-color as a result of manufacturing with epoxy coatings or other tooth-colored surfaces. Tooth-bonding-pads 104, 106, 108, 110, 112, 114, 116, 118, 120, 122, 124, 126, 128 and 130 can be removeably attached to any surface of a tooth.

While the system 100 is not limited to any particular archwire 102 and tooth-bonding-pads 104-130, for sake of clarity a simplified archwire 102 and tooth-bonding-pads 104-130 are described.

### Apparatus Implementations

In the previous section, a system level overview of the operation of an implementation was described. In this section, the particular apparatus of such an implementation are described by reference to a series of diagrams.

FIG. 2 is an occlusal view of a cross section block diagram of apparatus 200 according to an implementation illustrating an archwire passing through a pass-through recess of a tooth-bonding-pad. Apparatus 200 is a slideable unitary tooth-bonding-pad/archwire apparatus that does not have or include an orthodontic bracket, which as a result of the absent orthodontic bracket, can be fabricated easily, simply and inexpensively, and that has a low physical profile and a smaller height dimension that positions the archwire 102 further away from the inside of the cheek of a patient to which the apparatus 200 is applied, thus reducing friction of the inside of the cheek on the archwire 102, and thus improving comfort of the patient to which the apparatus 200 is applied.

In apparatus 200, the archwire 102 passes through a pass-through recess 202 of the tooth-bonding-pad. A pass-through recess 202 is a recess that extends completely through the tooth-bonding pad. In apparatus 200, the archwire 102 passes through the tooth-bonding-pad; the archwire 102 is not attached to the interior of the matter of the tooth-bonding-pad, but instead the archwire 102 can slide freely through the tooth-bonding-pad because of a gap 203 between the archwire 102 and the pass-through recess 202. The pass-through recess 202 is also known as a hole.

The tooth-bonding-pad in apparatus 200 is any one of the tooth-bonding-pads 104-130 shown in FIG. 1 and FIG. 2. In the implementation shown in FIG. 2, the tooth-bonding-pad includes a mesial-distal length 204 in a range of 1.5 mm to 3.0 mm, a standoff 204 in the range of 0.125 mm to 0.140 mm and a tooth-bonding-pad thickness 208 in a range of 1.5 mm to 4 mm. However, the disclosure herein is not limited to any particular dimensions of the pass-through recess 202, mesial-distal length 204, standoff 204, tooth-bonding-pad thickness 208, tooth-bonding-pads 104-130 or the archwire 102.

The absence of an orthodontic bracket in apparatus 200 provides a lower profile and a smaller tooth-bonding-pad thickness 208. The smaller tooth-bonding-pad thickness 208 of apparatus 200 positions the archwire 102 closer to the gingival and thus further away from the inside of the cheek of the patient, thus reducing friction between the inside of the cheek and the archwire 102, and therefore improving comfort of the patient.

Some implementations, a surface 210 of the tooth-bonding-pad 104-130 that can contact a tooth is microetched by a chemical process to condition the tooth-bonding-pad for better adhesion to a tooth or have a mesh thin screen wire attached or otherwise laminated to the tooth-bonding-pad.

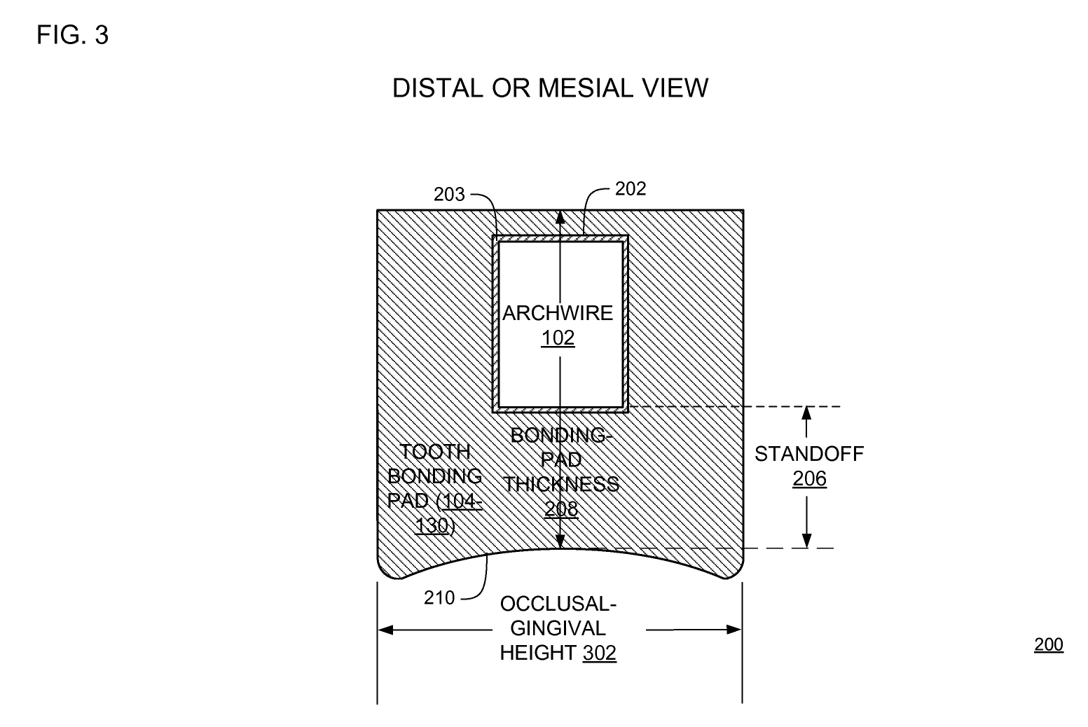

FIG. 3 is a distal or mesial view of a cross section block diagram of apparatus 200 according to an implementation illustrating an archwire passing through an interior of a tooth-bonding-pad.

In apparatus 200, the archwire 102 passes through the pass-through recess 202 a tooth-bonding-pad because of the gap 203 between the archwire 102 and the pass-through recess 202. The tooth-bonding-pad in apparatus 200 is any one of the tooth-bonding-pads 104-130 shown in FIG. 1 and FIG. 2. In the implementation shown in FIG. 3, the tooth-bonding-pad includes a distal-mesial length 204 in a range of 1.5 mm to 3.0 mm, an occlusal-gingival height 302 in a range of 1.5 mm to 4 mm and a tooth-bonding thickness 208 in a range of 0.10 mm to 2.0 mm. However, the disclosure herein is not limited to any particular dimensions of the pass-through recess 202, the distal-mesial length 204, tooth-bonding-pad thickness 208 or the archwire 102.

The archwire 102 and the pass-through recess 202 is depicted in FIG. 3 as being rectangular in cross-section. However, the geometry of the archwire 102 and/or the pass-through recess 202 can be any variety of geometries in cross-section, such as round, oval, eliptical, square, pentagular, heptangular, octangular, decangular, or asymmetrical.

FIGS. 2 and 3 show a curved surface onto which the tooth-bonding-pad adheres to the curved surface of the tooth. The geometry of the curved surface in FIGS. 2 and 3 is merely illustrative, and not necessarily exemplary and not limiting because curved surfaces of other geometries are within contemplation to accommodate tooth surface curvature geometries of a large variety.

FIG. 4 is a buccal view of a cross section block diagram of apparatus 200 according to an implementation illustrating an archwire passing through an interior of a tooth-bonding-pad.

In the implementation shown in FIGS. 2, 3 and 4, the tooth-bonding-pad 104-130 includes the pass-through recess 202, the mesial-distal length 204 in a range of 1.5 mm to 3.0 mm and the occlusal-gingival height 302 in a range of 1.5 mm to 4 mm.

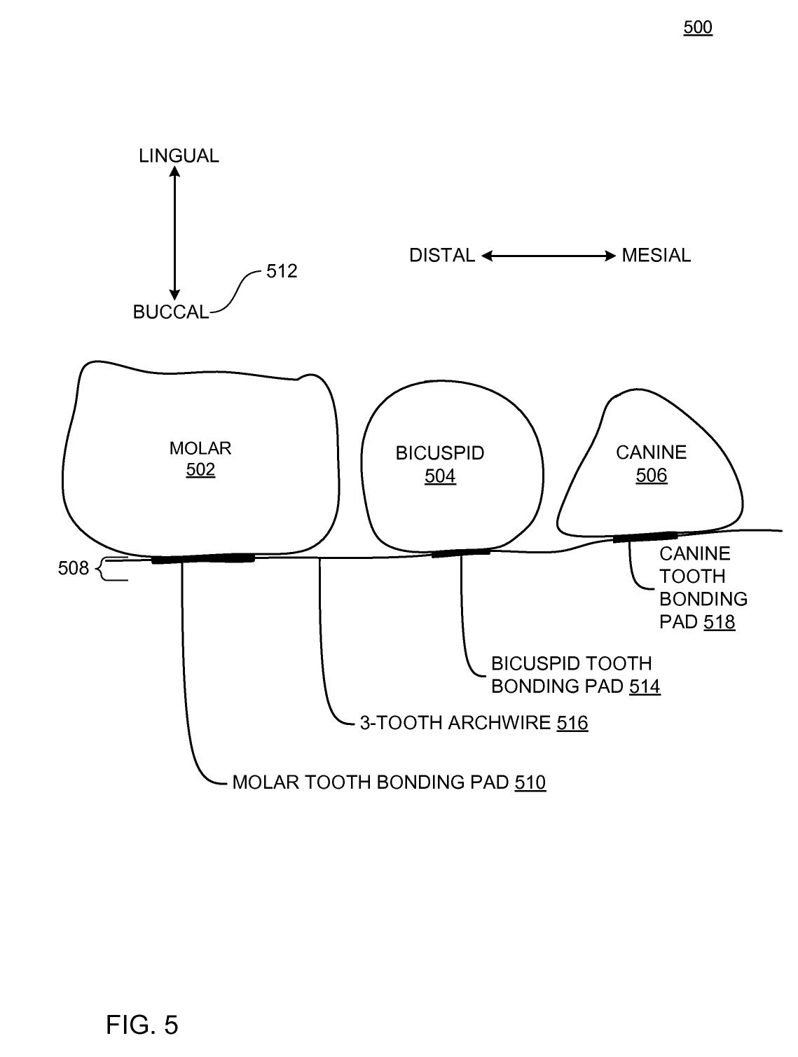

FIG. 5 is an occlusal-view block diagram of a slideable unitary tooth-bonding-pad/archwire apparatus 500 applied to a molar tooth, a bicuspid tooth and a canine tooth, according to an implementation. FIG. 5 shows a molar tooth 502, a bicuspid tooth 504 and a canine tooth 506. A slideable unitary tooth-bonding-pad/archwire apparatus 508 includes a molar tooth bonding pad 510 that is removeably attached to the buccal surface 512 of the molar tooth 502. The slideable unitary tooth-bonding-pad/archwire apparatus 508 includes a bicuspid tooth bonding pad 514 that is removeably attached to the buccal surface 512 of the bicuspid tooth 504. The slideable unitary tooth-bonding-pad/archwire apparatus 508 includes a canine tooth bonding pad 518 that is removeably attached to the buccal surface 512 of the canine tooth 506.

A three-tooth segment of archwire 516 of the slideable unitary tooth-bonding-pad/archwire apparatus 508 is attached to the molar tooth bonding pad 510, the bicuspid tooth bonding pad 514 and the canine tooth bonding pad 518.

Apparatus 100 and apparatus 200 are implementations of the slideable unitary tooth-bonding-pad/archwire apparatus 508. The slideable unitary tooth-bonding-pad/archwire apparatus 508 does not have or include an orthodontic bracket, which as a result of the absent orthordontic bracket the slideable unitary tooth-bonding-pad/archwire apparatus 508 can be fabricated easily, simply and inexpensively, and the slideable unitary tooth-bonding-pad/archwire apparatus 508 has a low physical profile and a smaller height dimension that positions the archwire further away from the inside of the cheek of the patient, thus reducing friction of the inside of the cheek on the archwire, and thus improving comfort of the patient.

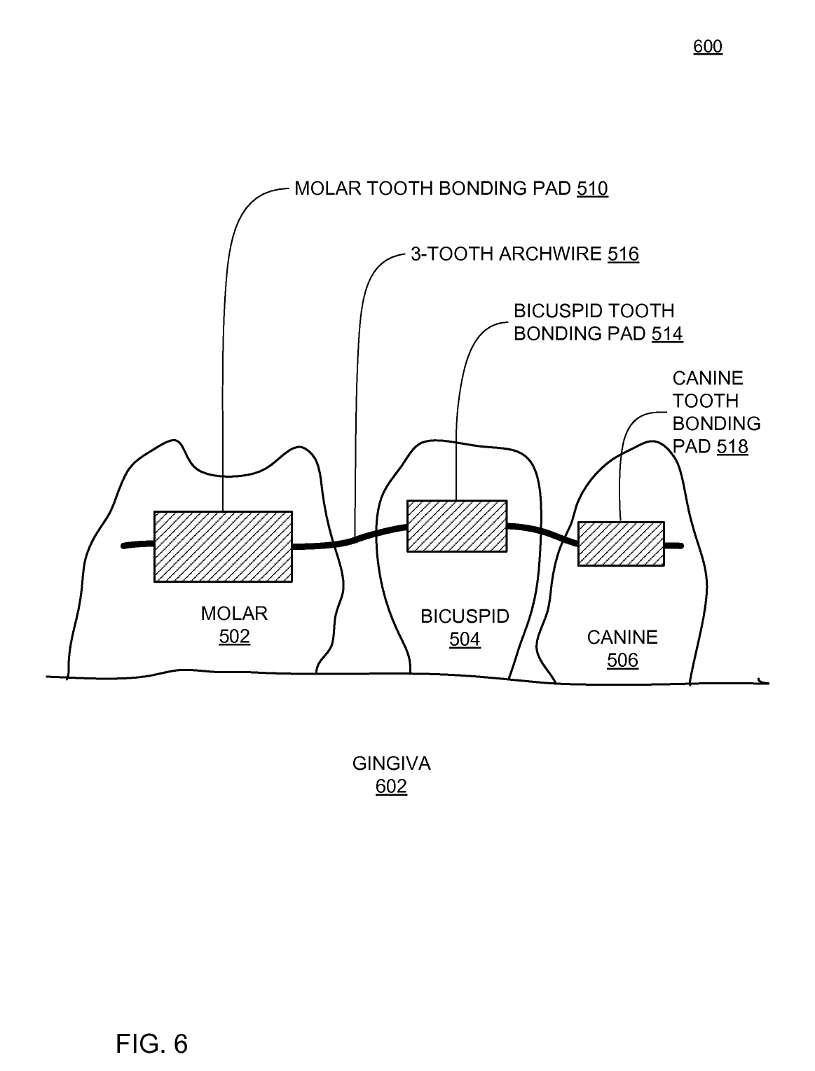

FIG. 6 is a buccal-view block diagram 600 of a slideable unitary tooth-bonding-pad/archwire apparatus applied to a molar tooth, a bicuspid tooth and a canine tooth, according to an implementation. FIG. 6 shows a molar tooth 502, a bicuspid tooth 504 and a canine tooth 506 situated in gingival tissue 602. A slideable unitary tooth-bonding-pad/archwire apparatus 508 includes a molar tooth bonding pad 510 that is removeably attached to the buccal surface 512 of the molar tooth 502. The slideable unitary tooth-bonding-pad/archwire apparatus 508 includes a bicuspid tooth bonding pad 514 that is removeably attached to the buccal surface 512 of the bicuspid tooth 504. The slideable unitary tooth-bonding-pad/archwire apparatus 508 includes a canine tooth bonding pad 518 that is removeably attached to the buccal surface 512 of the canine tooth 506.

A three-tooth segment of archwire 516 of the slideable unitary tooth-bonding-pad/archwire apparatus 508 is attached to the molar tooth bonding pad 510, the bicuspid tooth bonding pad 514 and the canine tooth bonding pad 518.

Apparatus 100 and apparatus 200 are implementations of the slideable unitary tooth-bonding-pad/archwire apparatus 508. The slideable unitary tooth-bonding-pad/archwire apparatus 508 does not have or include an orthodontic bracket, which as a result of the absent orthordontic bracket, the slideable unitary tooth-bonding-pad/archwire apparatus 508 can be fabricated easily, simply and inexpensively, and the slideable unitary tooth-bonding-pad/archwire apparatus 508 has a low physical profile and a smaller height dimension that positions the archwire further away from the inside of the cheek of a patient to which the slideable unitary tooth-bonding-pad/archwire apparatus 508 is applied, thus reducing friction of the inside of the cheek on the archwire 508, and thus improving comfort of the patient to which the slideable unitary tooth-bonding-pad/archwire apparatus 508 is applied.

FIG. 7 is a buccal side-view block diagram of a slideable unitary tooth-bonding-pad/archwire apparatus having a tubular holder 700 of the archwire applied to a bicuspid tooth, according to an implementation.

FIG. 7 shows a bicuspid tooth 504 situated in gingival tissue 602. The slideable unitary tooth-bonding-pad/archwire apparatus 700 includes a bicuspid tooth bonding pad 702 that is removeably attached to the buccal surface 512 of the bicuspid tooth 504. The slideable unitary tooth-bonding-pad/archwire apparatus 702 also includes a tubular holder 704 of the archwire 102.

The slideable unitary tooth-bonding-pad/archwire apparatus 700 does not have or include an orthodontic bracket, which as a result of the absent orthordontic bracket, the slideable unitary tooth-bonding-pad/archwire apparatus 700 can be fabricated easily, simply and inexpensively, and the slideable unitary tooth-bonding-pad/archwire apparatus 700 has a low physical profile and a smaller height dimension that positions the archwire further away from the inside of the cheek of a patient to which the slideable unitary tooth-bonding-pad/archwire apparatus 700 is applied, thus reducing friction of the inside of the cheek on the archwire 700, and thus improving comfort of the patient to which the slideable unitary tooth-bonding-pad/archwire apparatus 700 is applied.

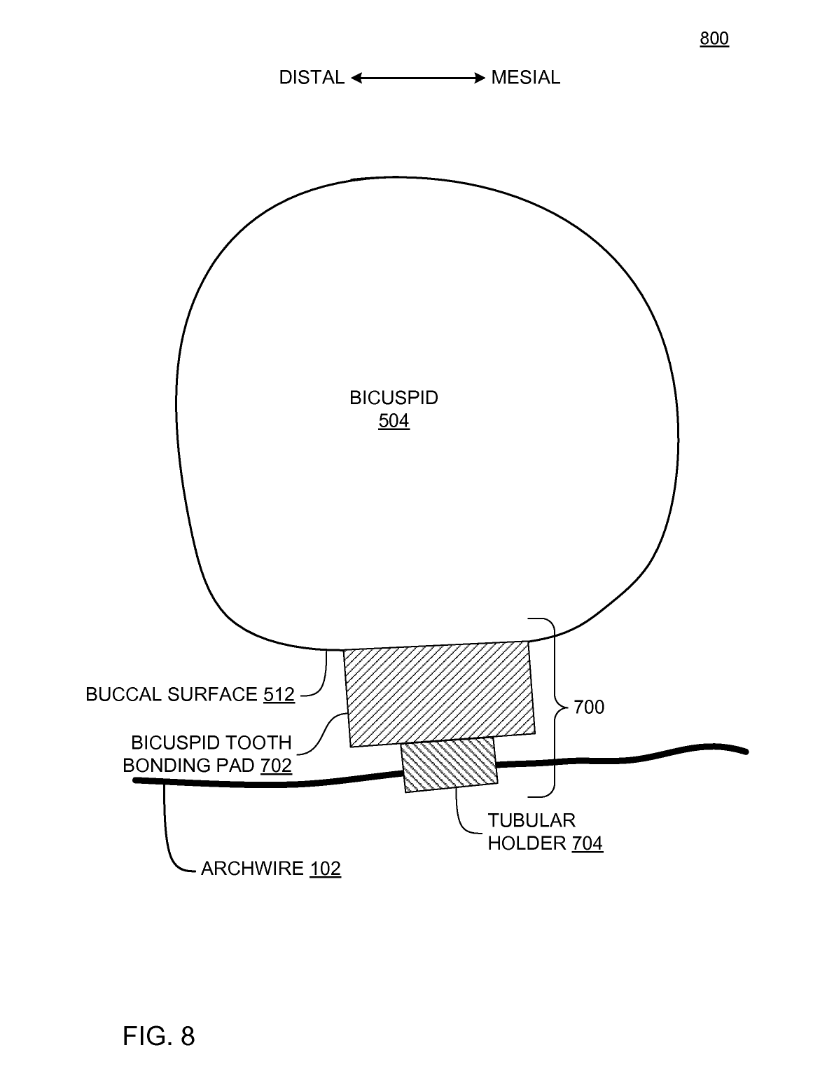

FIG. 8 is an occlusal-view block diagram of a slideable unitary tooth-bonding-pad/archwire apparatus 700 having a tubular holder of the archwire applied to a bicuspid tooth, according to an implementation.

FIG. 8 shows a bicuspid tooth 504. The slideable unitary tooth-bonding-pad/archwire apparatus 700 includes a bicuspid tooth bonding pad 702 that is removeably attached to the buccal surface 512 of the bicuspid tooth 504. The slideable unitary tooth-bonding-pad/archwire apparatus 700 also includes a tubular holder 704 of the archwire 102.

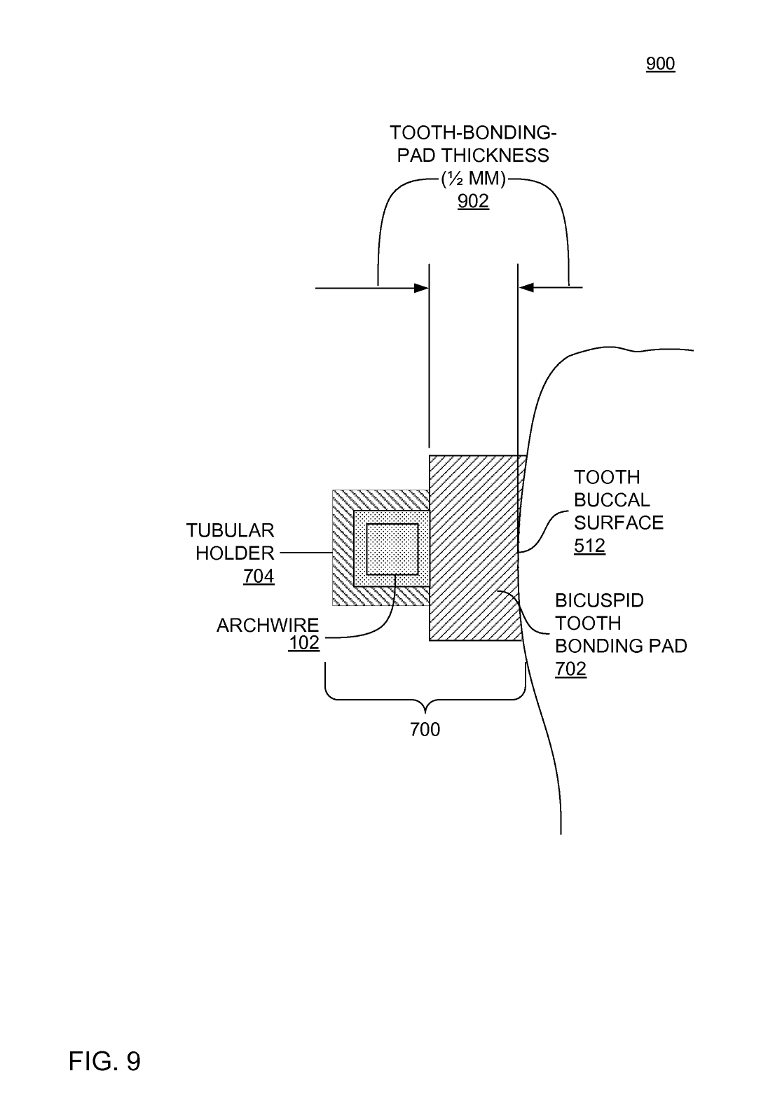

FIG. 9 is a mesial view block diagram of a slideable unitary tooth-bonding-pad/archwire apparatus 700 having a tubular holder of the archwire applied to a bicuspid tooth, according to an implementation.

FIG. 9 shows a bicuspid tooth 504. The slideable unitary tooth-bonding-pad/archwire apparatus 700 includes a bicuspid tooth bonding pad 702 that is removeably attached to the buccal surface 512 of the bicuspid tooth 504. The slideable unitary tooth-bonding-pad/archwire apparatus 700 also includes a tubular holder 704 of the archwire 102. The bonding pad 104-130 has a thickness 902.

The dimensions and sizes of apparatus shown in FIG. 7, FIG. 8 and FIG. 9 are not exemplary or limiting.

The geometries, shapes and dimensions of apparatus in FIGS. 1-9 are merely illustrative, and not necessarily exemplary and not limiting because other geometries, shapes and dimensions are within contemplation to accommodate tooth surfaces, sizes, geometries, shapes and dimensions of a large variety.

### Method Implementations

In the previous section, implementations of apparatus are described. In this section, particular methods of such those implementations are described by reference to a series of flowcharts.

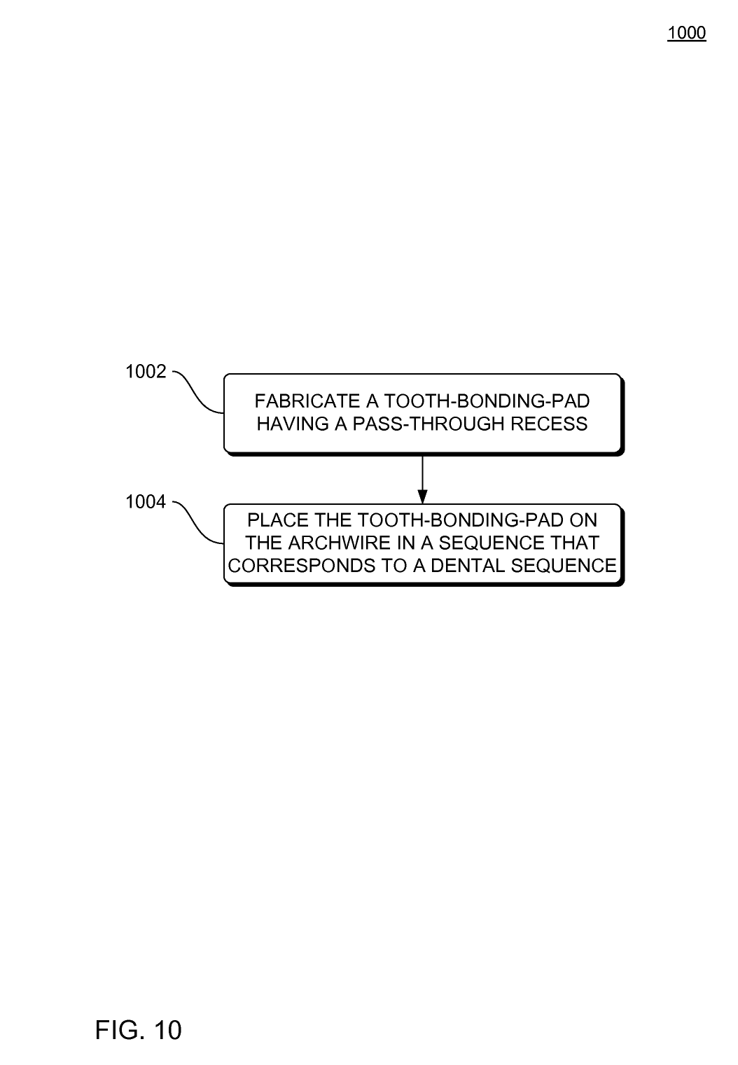

FIG. 10 is a flowchart of a method 1000 to fabricate a slideable unitary tooth-bonding-pad/archwire apparatus, according to an implementation. In method 1000, at least one tooth-bonding-pad and an archwire are transformed into a slideable unitary tooth-bonding-pad/archwire apparatus, such as apparatus 100, apparatus 200, apparatus 516, apparatus 700, apparatus 900 and apparatus 1200.

Method 1000 includes fabricating a tooth-bonding-pad having a pass-through recess, at block 1002. One example of the tooth-bonding-pads are tooth-bonding-pads 104-130 in FIG. 1.

Method 1000 includes placing the tooth-bonding-pad on the archwire in a sequence that corresponds to a dental sequence, at block 1004. One example of the archwire is archwire 102 in FIG. 1.

FIG. 11 is a flowchart of a method 1100 to implement a slideable unitary tooth-bonding-pad/archwire apparatus, according to an implementation before application of removable orthodontic appliance systems. Method 1100 provides effective treatment for orthodontic patients who are not originally practical candidates for removable orthodontic appliance systems.

At block 1102, if orthodontic malocclusion that is within the range that is conventionally diagnosed as treatable with removable applicant systems, then conventional treatment such as applying a conventional removable orthodontic appliance system to treat the malocclusion is performed at block 1104. However, if orthodontic malocclusion is outside of the range that is conventionally diagnosed as treatable with removable applicant systems, then at block 1106 in method 1100, an appropriately selected implementation of apparatus 100 is applied to a patient as an enabling appliance for orthodontic patients who, without prior treatment using apparatus 100, would not be practical candidates for complete and finishing orthodontic treatment with other removable orthodontic appliance systems. The appropriate implementation of apparatus 100 is based in part on the implementation variations described in FIG. 25 and FIG. 26. Some orthodontic patients who are not practical candidates for removable orthodontic appliance systems have less severe dental malocclusions and/or relapse of prior complete orthodontic treatment. Specifically, there are many cases of orthodontic malocclusion which cannot be fully treated with Invisalign® removable teeth aligner appliances alone. A significant number of patients having dental malocclusion can brought into the treatment range of Invisalign® removable teeth aligner appliances with a prior short-term application of apparatus 100. Additionally, many cases of malocclusion which are already treatable with Invisalign® removable teeth aligner appliances can be properly prepared for express treatment using Invisalign® removable teeth aligner appliances at a significantly overall reduced cost, and with less wear time by the patient.

After the application of apparatus 100 has achieved results that improve the prognosis for application of removable orthodontic appliance systems, apparatus 100 is removed from the patient, at block 1108, and then a conventional removable orthodontic realigner-retainer appliance system is applied to the patient, at block 1104.

FIG. 12 is a flowchart of a method 1200 to implement a slideable unitary tooth-bonding-pad/archwire apparatus, to correct orthodontic relapse. Method 1200 provides effective treatment for orthodontic patients whose prior orthodontic treatment has relapsed or regressed.

If orthodontic relapse is not diagnosed, at block 1202, then conventional post-treatment retention is performed. However orthodontic relapse is diagnosed at block 1202, because the degree of relapse is outside the range of treatment of a conventional realigner-retainer appliance, an appropriately selected implementation of apparatus 100 is applied to the relapsed arches of the patient to bring the degree of orthodontic correction back within range of a realigner or a retainer, at block 1106. The appropriate implementation of apparatus 100 is based in part on the implementation variations described in FIG. 25 and FIG. 26.

After the application of apparatus 100 has achieved results that improve the prognosis for application of removable orthodontic appliance systems, apparatus 100 is removed from the patient, at block 1108, and the conventional orthodontic realigner/retainer appliance system is applied to the patient, at block 1206.

FIG. 13 is a flowchart of a method 1300 to implement a slideable unitary tooth-bonding-pad/archwire apparatus, to facilitate the application of interceptive removable orthodontic devices on patients who are in a mixed dentition age range. Patients who are in a mixed dentition age range have one or more teeth are positioned such that the implementation of interceptive devices are be contraindicated, these problematically positioned teeth can be moved into positions by apparatus 100 to the extent that the new positions permit the implementation of these interceptive appliances.

When considering the use of a conventional interceptive orthodontic appliance for patients in the age range of mixed dentition if one or more malpositioned teeth contraindicate the use of conventional interceptive orthodontic appliances at block 1302, apparatus 100 can be applied to the patient, at block 1106, to bring the malpositioned teeth into positions that permit the use of the conventional interceptive orthodontic appliance on the patient. If the patient has no malpositioned teeth that contraindicat the use of the conventional interceptive orthodontic appliance, then the conventional interceptive orthodontic appliance is applied in a conventional manner, at block 1304.

After the application of apparatus 100 has achieved results that improve the prognosis for application of interceptive appliances, apparatus 100 is removed from the patient, at block 1108, and the interceptive appliance is applied to the patient, at block 1306.

Interceptive orthodontic appliances include Frankel orthodontic appliances, Schwarz orthodontic appliances and Bionator orthodontic appliances. Method 1300 provides effective treatment for orthodontic patients who are in a mixed dentition age range.

FIG. 14 is a flowchart of a method 1400 to implement a slideable unitary tooth-bonding-pad/archwire apparatus, to correct a minor orthodontic malocclusion. Method 1400 provides effective treatment for orthodontic patients having a minor orthodontic malocclusion.

In method 1400, if a minor malocclusion in one or more arches is not diagnosed at block 1402, then no orthodontic treatment is performed at block 1404. However, if a minor malocclusion in one or more arches is diagnosed, at block 1402, in response to diagnosis of the minor orthodontic malocclusion, apparatus 100 is applied to the patient, at block 1106, to correct the minor orthodontic malocclusion. An example of a minor orthodontic malocclusion is a dental malocclusion that includes only minor tooth displacements, such as buccal-lingual displacements, rotations, tipping, and/or vertical height discrepancies.

After the application of apparatus 100 has corrected the minor orthodontic malocclusion, apparatus 100 is removed from the patient, at block 1108.

In some implementations, following completion of orthodontic treatment involving apparatus 100, any conventional orthodontic retainer, such as a Hawley orthodontic appliance, is applied to the patient at block 1406 to retain the orthodontic result.

FIG. 15 is a flowchart of a method 1500 to implement a slideable unitary tooth-bonding-pad/archwire apparatus, in coordination with application of crowns and abutments.

Apparatus 100 can be applied prior to crown and bridge work in dentistry. When one or more of teeth that are to be prepared for crowns or as abutments for bridgework are in less than ideal positions, apparatus 100 can be implemented to better position these teeth for stress bearing associated with chewing forces, and also to allow for a more aesthetically appearing cosmetic result. For example, for teeth which are tipped or displaced from ideal positions of the teeth, orthodontic correction toward ideal positions of the teeth would permit the forces of mastication to be correctly directed along the long axis of the tooth, instead of producing periodontally unhealthy excessive lateral force components. Also, when anterior crowns are applied, significant labial-lingual misalignment can often be greater than can be compensated by selective tooth reduction alone. When the labial-lingual misalignment is greater than can be compensated by selective tooth reduction alone, short term correction involving apparatus 100 aligns the anterior teeth so that conservative crown preparation will allow for a cosmetically ideal result.

If conventional preparation of a crown or a bridge is not contra-indicated because of tooth misalignment, at block 1502, the conventional preparation of a crown or bridge without using apparatus 100 is performed, at block 1504. However, if conventional preparation of a crown or a bridge is contra-indicated because of tooth misalignment, at block 1502, then an appropriately selected implementation of apparatus 100 is applied to the patient to better position the teeth for stress bearing associated with chewing force, at block 1106.

After the application of apparatus 100 has achieved results that improve the prognosis for application of crowns and/or bridges, apparatus 100 is removed from the patient and the tooth or teeth are conventionally prepared for an ideal crown or bridge result and a temporary crown or bridge coverage is applied based on conventional techniques, at block 1108, and conventional preparation of a crown or bridge without using apparatus 100 is performed, at block 1504.

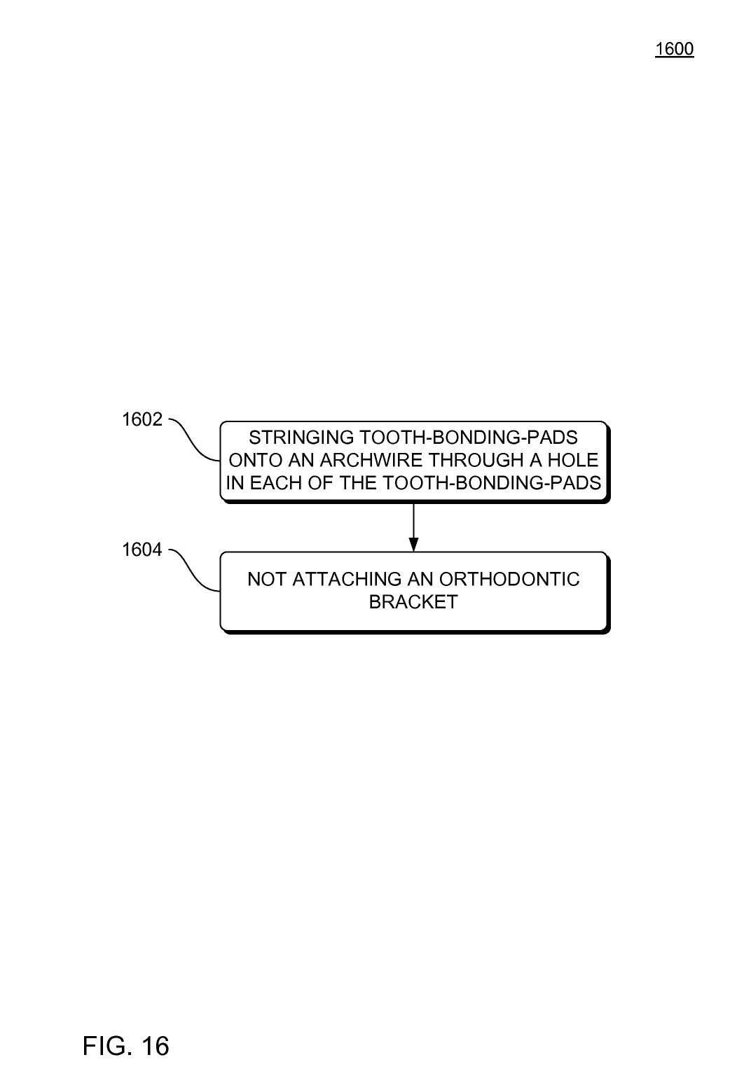

FIG. 16 is a block diagram of a method 1600 of stringing a plurality of tooth-bonding-pads onto an archwire, according to an implementation.

In some aspects, method 1600 includes stringing a plurality of tooth-bonding-pads onto an archwire through a hole in each of the plurality of tooth-bonding-pads, at block 1602. Examples of the tooth-bonding-pads include tooth-bonding-pads 104-130 in FIG. 1-4 and tooth-bonding-pads 510, 514 and 518 in FIG. 5-6. In some implementations, the holes are in a tubular holder 704 in FIG. 7 of the tooth-bonding-pads.

In some implementations, method 1600 includes not attaching an orthodontic bracket to any of the tooth-bonding-pads or the archwire, at block 1604.

In some implementations of method 1600, the plurality of tooth-bonding-pads includes 14 tooth-bonding-pads. In some implementations of method 1600, an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations of method 1600, the orientation of each of the tooth-bonding-pads includes providing the tooth-bonding-pads as accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations of method 1600, method 1600 includes producing at least one contour of each of the tooth-bonding-pads based on existing statistical norms of the labial and buccal surfaces of human teeth. In some implementations of method 1600, each of the tooth-bonding-pads have an occlusal-gingival height in a range of 1.5 mm to 4 mm and a mesial-distal length in a range of 1.5 mm to 3.0 mm. In some implementations of method 1600, the archwire includes thermally activated nickel-titanium metal. In some implementations of method 1600, the thermally activated nickel-titanium metal includes force activation occurring at a temperature of approximately 27 degrees Celsius. In some implementations of method 1600, the archwire includes a diameter selected from the group of diameters consisting of 0.012 round, 0.014 round, 0.016 round, and 0.016×0.0016 rectangular cross section. In some implementations of method 1600, the archwire includes a tooth-color as a result of manufacturing with epoxy coatings or other tooth-colored surfaces. In some implementations of method 1600, the at least one of the plurality of tooth-bonding-pads includes a tooth-color as a result of manufacturing with epoxy coatings or other tooth-colored surfaces.

The methods disclosed herein do not include attaching or including a bracket to the apparatus.

### Conclusion

A slideable tooth-bonding-pad/archwire system that does not include an orthodontic bracket is described herein.

In one implementation, a plurality of orthodontic archwires each have tooth bonding pads attached in specified locations. Five archwires of standardized archform geometry for the maxillary arch for each specified diameter or cross-section, and five archwires of standardized archform geometry for the mandibular arch for each specified diameter or cross section. As there are four specified diameters or cross-sections of archwires for each of the five standardized archform geometries, a total of twenty archwires can be fabricated for the upper arch, and a total of twenty archwires can be fabricated for the lower arch. Each archwire has a dental midline marking.

In some aspects, an apparatus consists of an archwire, and a plurality of tooth-bonding-pads each of the plurality of tooth-bonding-pads is slidably mounted on the archwire each of the tooth-bonding-pads are conditioned for better adhesion the apparatus has at least one pass-through recess the archwire passes through each of the at least one pass-through recess. In some implementations, the pass-through recess includes a pass-through recess in each of the tooth-bonding-pads. In some implementations, the apparatus includes a tubular holder fixedly mounted to each of the tooth-bonding-pads, each of the plurality of tubular holders having a pass-through recess. In some implementations, the plurality of tooth-bonding-pads further comprise: 14 tooth-bonding-pads. In some implementations, each of the tooth-bonding-pads further comprise: an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads further comprise: providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, each of the tooth-bonding-pads further comprise: at least one contour of each of the tooth-bonding-pads is produced from existing statistical norms of the labial and buccal surfaces of human teeth. In some implementations, each of the tooth-bonding-pads further comprise: an occlusal-gingival height in a range of 1.5 mm to 4 mm and a mesial-distal length in a range of 1.5 mm to 3.0 mm. In some implementations, the archwire includes thermally activated nickel-titanium metal. In some implementations, the thermally activated nickel-titanium metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches in diameter rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces. In some implementations, each of the plurality of tooth-bonding-pads is permanently fabricated to the archwire includes each of the plurality of tooth-bonding-pads is permanently fabricated onto the archwire. In some implementations, each of the plurality of tooth-bonding-pads is permanently fabricated to the archwire includes each of the plurality of tooth-bonding-pads is permanently fabricated into the archwire. In some implementations, the archwire includes no other apparatus.

In some aspects, an apparatus includes an archwire, and a plurality of tooth-bonding-pads each of the plurality of tooth-bonding-pads is slidably mounted on the archwire each of the tooth-bonding-pads are conditioned for better adhesion the apparatus has at least one pass-through recess the archwire passes through each of the at least one pass-through recess. In some implementations, the pass-through recess includes a pass-through recess in each of the tooth-bonding-pads. In some implementations, the apparatus includes a tubular holder fixedly mounted to each of the tooth-bonding-pads, each of the plurality of tubular holders having a pass-through recess. In some implementations, the plurality of tooth-bonding-pads further comprise: 14 tooth-bonding-pads. In some implementations, each of the tooth-bonding-pads further comprise: an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads further comprise: providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, each of the tooth-bonding-pads further comprise: at least one contour of each of the tooth-bonding-pads is produced from existing statistical norms of the labial and buccal surfaces of human teeth. In some implementations, each of the tooth-bonding-pads further comprise: an occlusal-gingival height in a range of 1.5 mm to 4 mm and a mesial-distal length in a range of 1.5 mm to 3.0 mm. In some implementations, the archwire includes thermally activated nickel-titanium metal. In some implementations, the thermally activated nickel-titanium metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches in diameter rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces. In some implementations, each of the plurality of tooth-bonding-pads is permanently fabricated to the archwire includes each of the plurality of tooth-bonding-pads is permanently fabricated onto the archwire. In some implementations, each of the plurality of tooth-bonding-pads is permanently fabricated to the archwire includes each of the plurality of tooth-bonding-pads is permanently fabricated into the archwire.

In some aspects, an apparatus consists essentially of a plurality of tooth-bonding-pads each of the plurality of tooth-bonding-pads includes a pass-through recess, and an archwire passing through each pass-through recess of each of the plurality of tooth-bonding-pads. In some implementations, the plurality of tooth-bonding-pads further comprise: 14 tooth-bonding-pads. In some implementations, each of the tooth-bonding-pads further comprise: an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads further comprise: providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, each of the tooth-bonding-pads further comprise: at least one contour of each of the tooth-bonding-pads is produced from existing statistical norms of the labial and buccal surfaces of human teeth. In some implementations, each of the tooth-bonding-pads further comprise: an occlusal-gingival height in a range of 1.5 mm to 4 mm and a mesial-distal length in a range of 1.5 mm to 3.0 mm. In some implementations, the archwire includes thermally activated nickel-titanium metal, with force activation occurring at approximately 27 degrees Celsius and approximately 81 degrees Fahrenheit. In some implementations, the archwire includes a diameter selected from the group of diameters consisting of 0.012 inches in diameter round, 0.014 inches in diameter round, 0.016 inches in diameter round, and 0.016×0.016 inches in rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces.

In some aspects, an apparatus includes a plurality of tooth-bonding-pads each of the plurality of tooth-bonding-pad includes a pass-through recess, and an archwire passing though the pass-through recess of each of the plurality of tooth-bonding-pads. In some implementations, the plurality of tooth-bonding-pads further comprise: 14 tooth-bonding-pads. In some implementations, each of the tooth-bonding-pads further comprise: an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations, the orientation of each of the tooth-bonding-pads further comprise: providing the tooth-bonding-pads are accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, each of the tooth-bonding-pads further comprise: at least one contour of each of the tooth-bonding-pads is produced from existing statistical norms of the labial and buccal surfaces of human teeth. In some implementations, each of the tooth-bonding-pads further comprise: an occlusal-gingival height in a range of 1.5 mm to 4 mm and a mesial-distal length in a range of 1.5 mm to 3.0 mm. In some implementations, the archwire includes thermally activated nickel-titanium metal. In some implementations, the thermally activated nickel-titanium metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches rectangular cross section. In some implementations, the archwire includes a tooth-color as a result of manufacturing with epoxy coatings or other tooth-colored surfaces. In some implementations, the at least one of the plurality of tooth-bonding-pads includes a tooth-color as a result of manufacturing with epoxy coatings or other tooth-colored surfaces.

In some aspects, an apparatus consists of an archwire, and at least one tooth-bonding-pad slidably mounted on the archwire. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of the human teeth. In some implementations, the orientation of the at least one tooth-bonding-pad includes providing the at least one tooth-bonding-pad is accurately appositioned with labial and buccal aspects at occlusal-gingival center and mesial-distal center to the extent that human teeth that are not in orthodontically correct positions will experience corrective orthodontic forces moving the human teeth toward orthodontically correct positions. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the at least one tooth-bonding-pad includes a tooth-color as a result of manufacturing with epoxy coatings or other tooth-colored surfaces. In some implementations, the archwire includes thermally activated nickel-titanium metal. In some implementations, the thermally activated nickel-titanium metal includes force activation occurring at a temperature of approximately 27 degrees Celsius. In some implementations, the archwire includes a diameter selected from the group of diameters consisting of 0.012 inches in diameter round, 0.014 inches in diameter round, 0.016 inches in diameter round, and 0.016×0.016 inches rectangular cross section. In some implementations, the archwire includes a tooth-color as a result of manufacturing with epoxy coatings or other tooth-colored surfaces.

In some aspects, an apparatus consists essentially of an archwire, and at least one tooth-bonding-pad slidably mounted on the archwire. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of human teeth. In some implementations, the orientation of the at least one tooth-bonding-pad includes providing the at least one tooth-bonding-pad is accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the archwire includes thermally activated nickel-titanium metal, with force activation occurring at approximately 27 degrees Celsius and approximately 81 degrees Fahrenheit. In some implementations, the archwire includes a diameter selected from the group of diameters consisting of 0.012 round, 0.014 round, 0.016 round, and 0.016×0.0016 rectangular cross section. In some implementations, the archwire includes a tooth-color as a result of manufacturing with epoxy coatings or other tooth-colored surfaces. In some implementations, the at least one tooth-bonding-pad includes a tooth-color as a result of manufacturing with epoxy coatings or other tooth-colored surfaces.

In some aspects, an apparatus includes an archwire, and at least one tooth-bonding-pad movably mounted on the archwire. In some implementations, the apparatus includes not having an orthodontic bracket. In some implementations, the at least one tooth-bonding-pad includes 14 tooth-bonding-pads. In some implementations, the at least one tooth-bonding-pad includes an orientation of the at least one tooth-bonding-pad to the archwire is such that when the at least one tooth-bonding-pad is applied to human teeth that are in orthodontically correct positions in all three planes of space, contours of exterior surfaces of the at least one tooth-bonding-pad accurately apposition with the occlusal-gingival center and the mesial-distal center of the labial and buccal contours of the human teeth. In some implementations, the orientation of the at least one tooth-bonding-pad includes providing the at least one tooth-bonding-pad is accurately appositioned with labial and buccal aspects at occlusal-gingival center and mesial-distal center to the extent that human teeth that are not in orthodontically correct positions will experience corrective orthodontic forces moving the human teeth toward orthodontically correct positions. In some implementations, the at least one tooth-bonding-pad includes at least one contour of the at least one tooth-bonding-pad is produced from existing statistical norms of the labial and buccal surfaces of human teeth. In some implementations, the at least one tooth-bonding-pad includes an occlusal-gingival height in a range of 1.5 mm to 4 mm and a mesial-distal length in a range of 1.5 mm to 3.0 mm. In some implementations, the at least one tooth-bonding-pad includes a tooth-color as a result of manufacturing with epoxy coatings or other tooth-colored surfaces. In some implementations, the archwire includes thermally activated nickel-titanium metal. In some implementations, the thermally activated nickel-titanium metal includes force activation occurring at a temperature of approximately 27 degrees Celsius. In some implementations, the archwire includes a diameter selected from the group of diameters consisting of 0.012 round, 0.014 round, 0.016 round, and 0.016×0.0016 rectangular cross section. In some implementations, the archwire includes a tooth-color as a result of manufacturing with epoxy coatings or other tooth-colored surfaces.

In some aspects, a method includes stringing a plurality of tooth-bonding-pads onto an archwire through a hole in each of the plurality of tooth-bonding-pads. In some implementations, the method does not include attaching an orthodontic bracket. In some implementations of the method, the plurality of tooth-bonding-pads includes 14 tooth-bonding-pads. In some implementations of the method an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth. In some implementations of the method, the orientation of each of the tooth-bonding-pads further comprise: providing the tooth-bonding-pads as accurately appositioned with labial and buccal aspects at occlusal-gingival center and mesial-distal center to the extent that teeth that are not in orthodontically correct positions will experience corrective orthodontic forces moving the human teeth toward orthodontically correct positions. In some implementations the method includes producing at least one contour of each of the tooth-bonding-pads based on existing statistical norms of the labial and buccal surfaces of human teeth. In some implementations of the method, each of the tooth-bonding-pads further comprise: an occlusal-gingival height in a range of 1.5 mm to 4 mm and a mesial-distal length in a range of 1.5 mm to 3.0 mm. In some implementations of the method, the archwire includes thermally activated nickel-titanium metal. In some implementations of the method, the thermally activated nickel-titanium metal includes force activation occurring at a temperature of approximately 27 degrees Celsius. In some implementations of the method, the archwire includes a diameter selected from the group of diameters consisting of 0.012 round, 0.014 round, 0.016 round, and 0.016×0.0016 rectangular cross section. In some implementations of the method, the archwire includes a tooth-color as a result of manufacturing with epoxy coatings or other tooth-colored surfaces. In some implementations of the method, the at least one of the plurality of tooth-bonding-pads includes a tooth-color as a result of manufacturing with epoxy coatings or other tooth-colored surfaces.

In some aspects, an apparatus includes an orthodontic tooth-bonding-pad the tooth-bonding-pad includes a pass-through recess. In some implementations, the plurality of tooth-bonding-pads further comprise: 14 tooth-bonding-pads. In some implementations, the tooth-bonding-pad further comprise: at least one contour of the tooth-bonding-pad is produced from existing statistical norms of the labial and buccal surfaces of human teeth. In some implementations, the tooth-bonding-pad further comprise: an occlusal-gingival height in a range of 1.5 mm to 4 mm and a mesial-distal length in a range of 1.5 mm to 3.0 mm. In some implementations, the tooth-bonding-pad includes a tooth-color as a result of manufacturing with epoxy coatings or other tooth-colored surfaces. In some implementations, the tooth-bonding-pad includes a mesh. In some implementations, the tooth-bonding-pad includes a mesh.

Although specific implementations are illustrated and described herein, it will be appreciated by those of ordinary skill in the art that any arrangement which is calculated to achieve the same purpose may be substituted for the specific implementations shown. This disclosure is intended to cover any adaptations or variations. For example, one of ordinary skill in the art will appreciate that implementations can be made in any material or any other process that provides the required function.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices can be introduced without departing from the scope of implementations. One of skill in the art will readily recognize that implementations are applicable to new archwires and different tooth-bonding-pads.

The terminology in this disclosure is meant to include all archwires and tooth-bonding pads and alternate technologies which provide the same functionality as described herein.

1. An apparatus consisting of:
an archwire; and
a plurality of tooth-bonding-pads, wherein each of the plurality of tooth-bonding-pads is slidably mounted on the archwire, wherein each of the tooth-bonding-pads are conditioned for better adhesion,
wherein the apparatus has at least one pass-through recess, wherein the archwire passes through each of the at least one pass-through recess.

2. The apparatus of claim 1, wherein the pass-through recess further comprises:
a pass-through recess in each of the tooth-bonding-pads.

3. The apparatus of claim 1, wherein the apparatus further comprises:
a tubular holder fixedly mounted to each of the tooth-bonding-pads, each of the plurality of tubular holders having a pass-through recess.

4. The apparatus of claim 1, wherein the plurality of tooth-bonding-pads further comprise:
14 tooth-bonding-pads.

5. The apparatus of claim 1, wherein each of the tooth-bonding-pads further comprise:
an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth.

6. (canceled)

7. (canceled)

8. (canceled)

9. (canceled)

10. (canceled)

11. (canceled)

12. (canceled)

13. (canceled)

14. The apparatus of claim 1, wherein each of the plurality of tooth-bonding-pads being permanently fabricated to the archwire further comprises:
each of the plurality of tooth-bonding-pads is permanently fabricated onto the archwire.

15. The apparatus of claim 1, wherein each of the plurality of tooth-bonding-pads being permanently fabricated to the archwire further comprises:
each of the plurality of tooth-bonding-pads is not permanently fabricated into the archwire.

16. An apparatus comprising:
an archwire; and
a plurality of tooth-bonding-pads, wherein each of the plurality of tooth-bonding-pads is slidably mounted on the archwire, wherein each of the tooth-bonding-pads are conditioned for better adhesion,
wherein the apparatus has at least one pass-through recess, wherein the archwire passes through each of the at least one pass-through recess.

17. The apparatus of claim 16, wherein the pass-through recess further comprises:
a pass-through recess in each of the tooth-bonding-pads.

18. The apparatus of claim 16, wherein the apparatus further comprises:
a tubular holder fixedly mounted to each of the tooth-bonding-pads, each of the plurality of tubular holders having a pass-through recess.

19. The apparatus of claim 16, wherein the plurality of tooth-bonding-pads further comprise:
14 tooth-bonding-pads.

20. The apparatus of claim 16, wherein each of the tooth-bonding-pads further comprise:
an orientation of each of the tooth-bonding-pads to the archwire are such that when the tooth-bonding-pads are applied to human teeth that are in orthodontically correct positions in all three planes of space, contours of exterior surfaces of the tooth-bonding-pads accurately apposition with the occlusal-gingival center and the mesial-distal center of the labial and buccal contours of the human teeth.

21. (canceled)

22. (canceled)

23. (canceled)

24. (canceled)

25. (canceled)

26. (canceled)

27. (canceled)

28. (canceled)

29. The apparatus of claim 16, wherein each of the plurality of tooth-bonding-pads being permanently fabricated to the archwire further comprises:
each of the plurality of tooth-bonding-pads is permanently fabricated onto the archwire.

30. The apparatus of claim 16, wherein each of the plurality of tooth-bonding-pads being permanently fabricated to the archwire further comprises:
each of the plurality of tooth-bonding-pads is not permanently fabricated into the archwire.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. An apparatus comprising:
an orthodontic tooth-bonding-pad, wherein the tooth-bonding-pad includes a pass-through recess.

98. The apparatus of claim 97, wherein the plurality of tooth-bonding-pads further comprise:
14 tooth-bonding-pads.

99. The apparatus of claim 97, wherein the tooth-bonding-pad further comprise:
at least one contour of the tooth-bonding-pad being produced from existing statistical norms of the labial and buccal surfaces of human teeth.

100. The apparatus of claim 97, wherein the tooth-bonding-pad further comprise:
an occlusal-gingival height in a range of 1.5 mm to 4 mm and a mesial-distal length in a range of 1.5 mm to 3.0 mm.

101. The apparatus of claim 97, wherein the tooth-bonding-pad further comprises:
a tooth-color as a result of manufacturing with epoxy coatings or other tooth-colored surfaces.

102. The apparatus of claim 97, wherein the tooth-bonding-pad further comprises:
a mesh.
